(19) United States
(12) Patent Application Publication
(10) Pub. No.: US 2024/0198329 A1
(43) Pub. Date: Jun. 20, 2024

(54) APPARATUS FOR TESTING A LIQUID SPECIMEN BY WICKING THE LIQUID SPECIMEN TO RESPONSE PORTIONS

(71) Applicant: CLINICAL DESIGN TECHNOLOGIES LIMITED, Somerset (GB)

(72) Inventor: Oliver BLACKWELL, Somerset (GB)

(21) Appl. No.: 18/573,592

(22) PCT Filed: Dec. 10, 2021
(86) PCT No.: PCT/GB2021/000140

§ 371 Date: Dec. 22, 2023

(30) Foreign Application Priority Data
Dec. 17, 2020 (GB) 2020007.7

(51) Int. Cl. B01L 3/00

(52) U.S. Cl. CPC B01L 3/5023; B01L 3/508; B01L 2300/042; B01L 2300/044; B01L 2300/047; B01L 2300/048; B01L 2400/0406

(57) ABSTRACT

Apparatus (2) for testing a liquid specimen (4), which apparatus (2) comprises: (i) a test chamber (6); (ii) a plurality of response portions (8) which are in the test chamber (6) and which are for responding to contact with the liquid specimen (4) to give at least one test result; and (iii) a wicking configuration (10) which enables the liquid specimen (4) to contact the response portions (8) only by a wicking action.

This invention relates to apparatus for testing a liquid specimen and, more especially, this invention relates to apparatus for testing a liquid specimen by wicking the liquid specimen to response portions.

A liquid specimen from a patient is often tested to diagnose or monitor one or more medical conditions of the patient. Typically the liquid specimen is handled and this presents clinical infection risks. Also, the liquid specimen may be unpleasant to handle, for example if the liquid specimen is urine.

It is an aim of the present invention to avoid or reduce the above mentioned problems.

Accordingly, the present invention provides apparatus for testing a liquid specimen, which apparatus comprises:
(i) a test chamber;
(ii) a plurality of response portions which are in the test chamber and which are for responding to contact with the liquid specimen to give at least one test result; and
(iii) a wicking configuration which enables the liquid specimen to contact the response portions only by a wicking action.

The apparatus of the present invention is advantageous in that the liquid specimen, for example urine, is able to be tested without the need for contact with the liquid specimen and the resultant clinical infection risks. The apparatus avoids excess liquid specimen in the vicinity of the response portions, for example as might occur with immersion of the response portions in the liquid specimen. The avoidance of the excess liquid specimen avoids over soaking the response portions, which might adversely affect the performance of the response portions or the accuracy of the obtained test results. Also, the avoidance of the excess liquid specimen is able to avoid excess liquid specimen obscuring viewing of the response portions through a viewing window, for example as may occur if the excess liquid specimen attaches to the viewing window.

The apparatus may be one in which the wicking configuration comprises a plurality of wicking apertures in a wall of the test chamber, and wicking formations in the wicking apertures.

The wicking apertures may be in a side wall of the test chamber. Alternatively, the wicking apertures may be in a bottom wall of the test chamber. Generally the wicking apertures may be located where required in the apparatus.

The wicking formations may protrude beyond the wicking apertures. Alternatively, the wicking formations may end in the wicking apertures.

The wicking formations may be ends of the response portions. Alternatively, the wicking formations may be ends of wicking carrier members which are for enabling the liquid specimen to wick to the response portions. The wicking formations may cover the wicking apertures. Other wicking formations may be employed.

The apparatus may include an openable membrane positioned for being opened in order to enable the wicking. The apparatus may be provided with any suitable openable configurations for opening the membrane.

The apparatus may include air inlet means for enabling air to contact the response portions. The air inlet means may be employed where the response portions require a supply of air to operate in an optimum manner. The air inlet means may be designed to prevent a person's finger making contact with the response portions. Various configurations for the air inlet means may be employed and which are such as to prevent a person's finger making contact with the response portions.

The air inlet means may be formed by open sides of the test chamber. Alternatively, the air inlet means may be formed by apertures in the test chamber, for example in a side wall of the test chamber.

The apparatus may be one which includes a test container, and in which the test chamber forms part of the test container.

The apparatus may include a collection container for collecting the liquid specimen. In this case, the apparatus may be one in which the test container is in the form of a lid, and in which the lid secures to the collection container.

The test chamber may be a removable fit to the remainder of the apparatus, for example by being a push fit or a screw fit. Alternatively, the test chamber may be formed as an integral non-removable part of the remainder of the apparatus.

The wicking action afforded by the wicking configuration may be such that the liquid specimen travels along the wicking configuration from one end to the other. The wicking action may be a capillary action or an osmotic action. The wicking action may be any absorption action by which the response portions absorb the wicked liquid specimen, as opposed to the response portions simply being immersed in the liquid specimen.

Embodiments of the invention will now be described solely by way of example and with reference to the accompanying drawings in which:

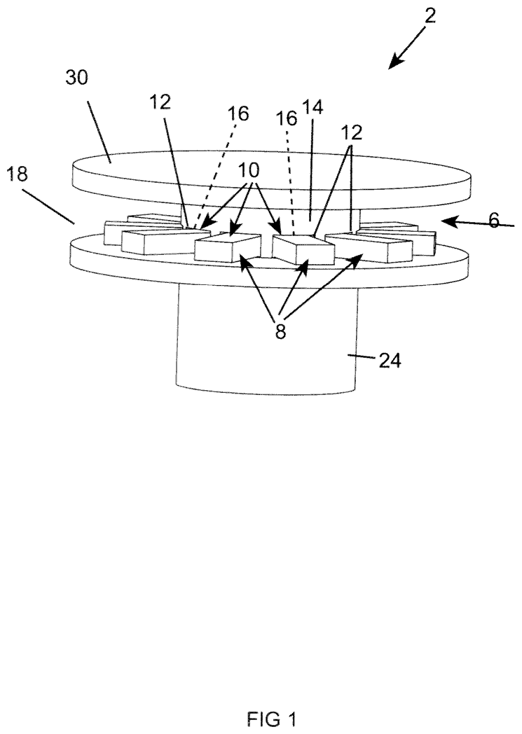

FIG. 1 is a view from one side and above of a part of first apparatus for testing a liquid specimen;

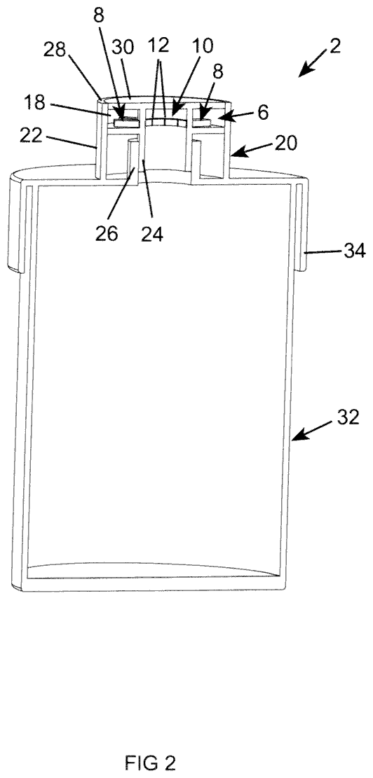

FIG. 2 is a section through the part of the apparatus shown in FIG. 1 fitted to the top of other parts of the first apparatus;

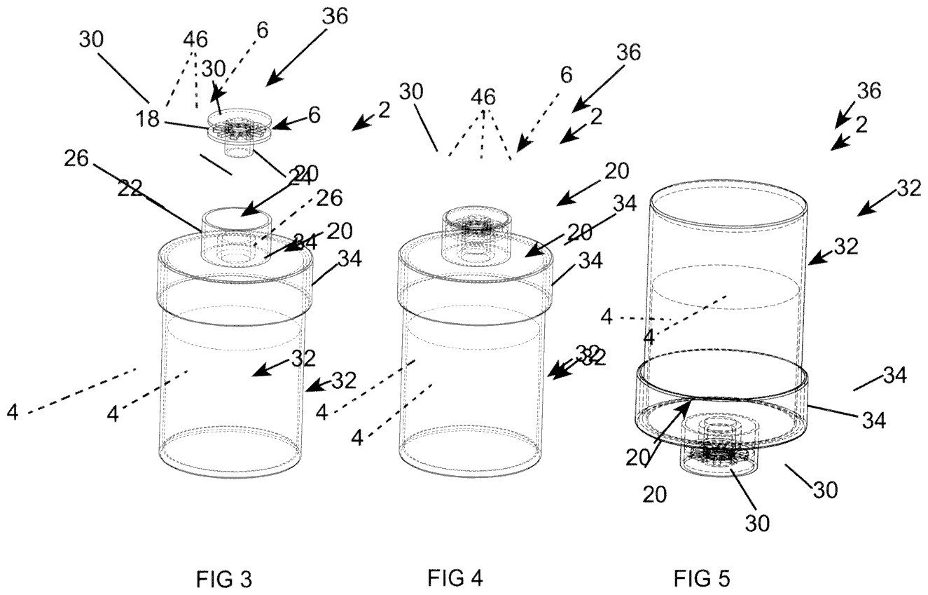

FIGS. 3, 4 and 5 show three sequential steps in use of the first apparatus shown in FIG. 2;

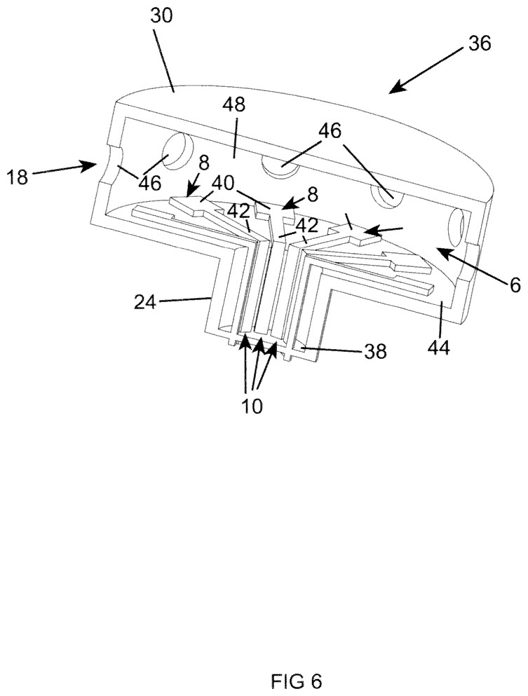

FIG. 6 is a view from one side and above of a perspective section through part of second apparatus for testing a liquid specimen;

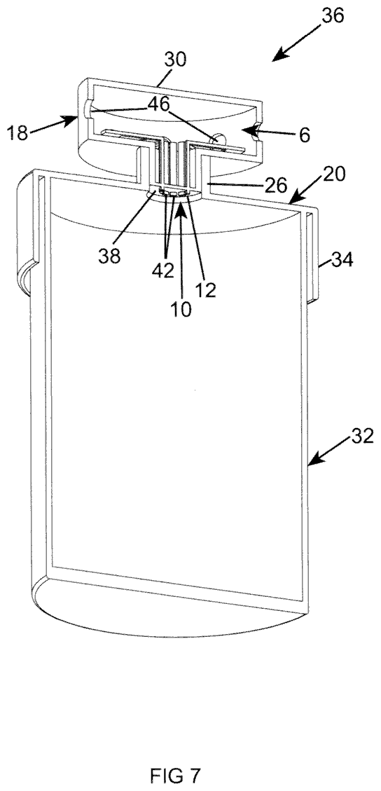

FIG. 7 shows the part shown in FIG. 6 fitted to other parts of the second apparatus; and

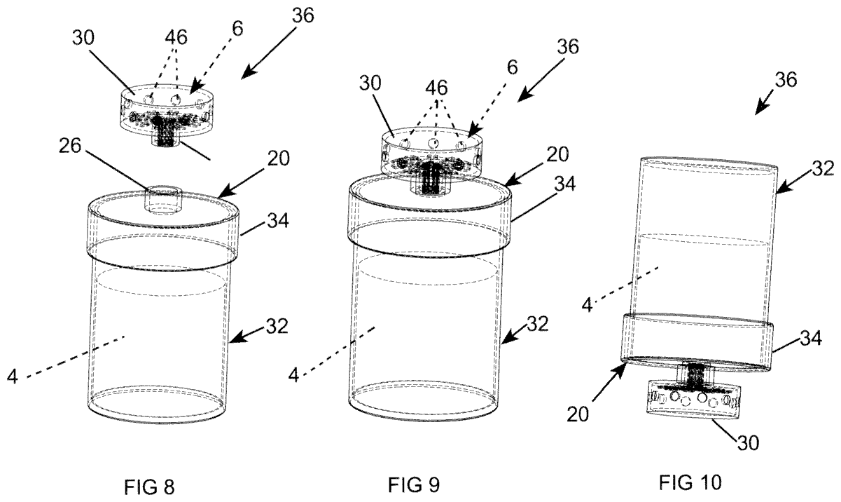

FIGS. 8, 9 and 10 show three sequential steps in use of the second apparatus shown in FIG. 7.

Referring to FIGS. 1-5, there is shown apparatus 2 for testing a liquid specimen 4. The apparatus 2 comprises a test chamber 6. The apparatus 2 also comprises a plurality of response portions 8 which are in the test chamber 6 and which are for responding to contact with the liquid specimen 4 to give at least one result. The apparatus 2 also comprises a wicking configuration 10 which enables the liquid specimen 4 to contact the response portions 8 only by a wicking action.

The wicking configuration 10 comprises a plurality of wicking apertures 12 in a wall 14 of the test chamber 6, and wicking formations 16 in the wicking apertures 12. The wall 14 is a side wall 14 of the test chamber 6.

The wicking formations 16 protrude beyond the wicking apertures 12 as can best be appreciated from FIG. 2. The wicking formations 16 are inner ends of the response portions 8.

The apparatus 2 includes air inlet means 18 for enabling air to contact the response portions 8. As can best be appreciated from FIG. 1, the air inlet means 18 is formed by open sides of the test chamber 6.

As shown in FIG. 2, the apparatus 2 includes a test container 20. The test chamber 6 forms part of the test container 20. More specifically, the part of the apparatus 2 shown in FIG. 1 is arranged to fit inside an upstanding wall 22 of the test container 20. In so doing, a cylindrical portion 24 fits within an upstanding wall 26 of the test container 20 as shown. The wicking apertures 12 as shown in FIG. 1 are shown enlarged for ease of illustration. In reality the wicking apertures 12 are smaller than shown so that the wicking formations 16 are tight against the parts of the wall 14 defining the wicking apertures 12. This is so that the liquid specimen 4 can only pass from the inside of the cylindrical portion 24 to the entire length of the response portions 8 by wicking through the wicking formations 16 as formed by the inner ends of the response portions 8. Air access to the air inlet means 18 is via a small gap 28 between the inside of the wall 22 and the periphery of a top part 30 of the part of the apparatus 2 comprising the test chamber 6, the response portions 8 and the wicking configuration 10.

The apparatus 2 includes a collection container 32 for collecting the liquid specimen 4. The test container 20 is in the form of a lid having a skirt 34. Thus the lid is able to secure to the collection container 32 as shown schematically in FIG. 2. The skirt 34 may secure to the top of the collection container 32 by being a screw fit or other suitable fit.

The test chamber 6 with the response portions 8 is a removable fit to the remainder of the apparatus 2. Thus, after contact of the response portions 8 by the liquid specimen 4, the test chamber 6 and the response portion 8 can be removed from the remainder of the apparatus 2 and tested as may be appropriate, for example in a laboratory. Alternatively, the test chamber 6 and the response portions 8 may be permanently connected to the remainder of the test container 20. The test container 20 can be constructed as a lid as shown in FIG. 2, and the lid can be screwed to the collection container 32. The lid can then be removed from the collection container 32 after the response portions 8 have been contacted by the liquid specimen 4. The response portions 8 can then be tested in the entire test container 20. The liquid specimen 4 can alternatively be tested by other means, for example in a laboratory by removing the liquid specimen 4 from the collection container 32.

FIGS. 3, 4 and 5 illustrate progressive steps in use of the apparatus 2 for testing the liquid specimen 4. More specifically, FIG. 3 illustrates how the part of the apparatus 2 shown in FIG. 1 is connected to other parts of the apparatus 2 such that the apparatus 2 is in the condition shown in FIG. 4. The condition shown in FIG. 4 is shown in cross section in FIG. 2. FIG. 5 shows the apparatus 2 inverted from the position shown in FIG. 4. In the inverted position, the liquid specimen 4 is able to enter the test chamber 6, and contact the response portions 8 via the wicking configuration 10.

Referring now to FIGS. 6-10, there is shown second apparatus 36 of the present invention. The apparatus 36 is shown such FIG. 6 corresponds to FIG. 1, FIG. 7 corresponds to FIG. 2 and FIGS. 8-10 correspond to FIGS. 3-5. Similar parts in the apparatus 2, 36 have been given the same reference numerals for ease of comparison and understanding.

As can best be seen from a comparison of FIGS. 1 and 6, the wicking configuration 10 in the apparatus 36 is such that the wicking apertures 12 are in a bottom wall 38 of the test chamber 6.

The response portions 8 in the apparatus 36 comprise view portions 40 and elongate portions 42 which extend from the view portions 40, along a surface 44 of the test chamber 6, down through the cylindrical portion 24 and through the wicking apertures 12 in the bottom wall 38. The protrusion of the elongate portions 42 through the wicking apertures 12 is best appreciated from FIG. 7.

In an alternative embodiment of the invention, the apparatus 36 may be such that the response portions 8 are solely formed by the view portions 40. In this case, the elongate portions 42 may be wicking carrier members which are for enabling the liquid specimen 4 to wick to the response portions 40. When the wicked liquid specimen 4 reaches the view portions 40, it is then able to wick along the view portions 40.

In the apparatus 36, the air inlet means 18 is formed by a plurality of apertures 46 which are in a side wall 48 of the test chamber 6.

The connection of the different component parts of the apparatus 36 together and the use of the apparatus 36 is shown in FIGS. 7-10, and is as described above in connection with FIGS. 2-5.

The apparatus 2, 36 is advantageous in that it enables the liquid specimen 4 easily and hygienically to be tested. The apparatus 2, 36 avoids excess liquid specimen 4 in the vicinity of the response portions 8, for example as might occur with immersion of the response portions 8 in the liquid specimen 4. The avoidance of excess liquid specimen 4 in turn prevents over-soaking of the response portions 8, which might adversely affect the performance of the response portions 8 or the accuracy of the obtained test results. In addition, excess liquid specimen 4 is prevented from obscuring viewing of the response portions 8, for example by the liquid specimen 4 attaching to a viewing window to which the response portions 8 are viewed. Typically, the apparatus 2, 36 is such that the response portions 8 are viewed through a viewing window (not shown) in the top part 30. The viewing window may be of any suitable configuration which provides good viewing of the response portions 8.

It is to be appreciated that the embodiments of the invention described above with reference to the accompanying drawings have been given by way of example only and that modifications may be effected. Thus, for example, the shape of the test chamber 6, the response portions 8 and the wicking configuration 10 may be varied. The apparatus may include an openable formation for opening an openable membrane in order to enable the wicking. The apparatus 2, 36 may operate with various types of wicking action including, for example, capillary action and osmotic action. The liquid specimen 4 shown in the drawings is urine but the liquid specimen 4 may be other liquid specimens including bodily fluids such for example as blood. Individual components shown in the drawings are not limited to use in their drawings and they may be used in other drawings and in all aspects of the invention. The invention also extends to the individual components mentioned and/or shown above, taken singly or in any combination.

1. Apparatus for testing a liquid specimen, which apparatus comprises:
(i) a test chamber;
(ii) a plurality of response portions which are in the test chamber and which are for responding to contact with the liquid specimen to give at least one test result; and
(iii) a wicking configuration which enables the liquid specimen to contact the response portions only by a wicking action.

2. The apparatus according to claim 1, wherein the wicking configuration comprises a plurality of wicking apertures in a wall of the test chamber, and wicking formations in the wicking apertures.

3. The apparatus according to claim 2, wherein the wicking apertures are in a side wall of the test chamber.

4. The apparatus according to claim 2, wherein the wicking apertures are in a bottom wall of the test chamber.

5. The apparatus according to claim 2, wherein in which the wicking formations protrude beyond the wicking apertures.

6. The apparatus according to claim 2 in which the wicking formations are ends of the response portions.

7. The apparatus according to claim 2, wherein the wicking formations are ends of wicking carrier members which are for enabling the liquid specimen to wick to the response portions.

8. The apparatus according to claim 2, wherein the wicking formations cover the wicking apertures.

9. The apparatus according to claim 1, further comprising an openable membrane positioned for being opened in order to enable the wicking.

10. The apparatus according to claim 1, further comprising air inlet means for enabling air to contact the response portions.

11. The apparatus according to claim 10, wherein the air inlet means is formed by open sides of the test chamber.

12. The apparatus according to claim 10, wherein the air inlet means is formed by apertures in the test chamber.

13. The apparatus according to claim 1, wherein, the apparatus includes a test container, and in which the test chamber forms part of the test container.

14. The apparatus according to claim 1, wherein the apparatus includes a collection container for collecting the liquid specimen.

15. The apparatus according to claim 13, wherein the apparatus includes a collection container for collecting the liquid specimen, the test container is in the form of a lid, and the lid secures to the collection container.

16. The apparatus according to claim 13, wherein the test container is a removable fit to the remainder of the apparatus.
